(19) United States
(12) Patent Application Publication
(10) Pub. No.: US 2007/0070090 A1
(43) Pub. Date: Mar. 29, 2007

(54) Vehicle navigation system

(76) Inventors: Lisa Debettencourt, Lowell, MA (US); James T. Hotary, Princeton, MA (US); Andrew Olcott, Newton, MA (US); John Michael Sakalowsky, West Newton, MA (US)

Correspondence Address: FISH & RICHARDSON PC, P.O. BOX 1022, MINNEAPOLIS, MN, 55440-1022, US

(21) Appl. No.: 11/233,888

(22) Filed: Sep. 23, 2005

(51) Int. Cl. G09G 5/00

(52) U.S. Cl. 345/672

(57) ABSTRACT

Methods and apparatus for manipulating a map in a navigation system are described. A navigation system includes a first control having a first function that orients a panning axis relative to a display in the navigation system. A second control includes a first function that moves the map along the panning axis. The second control is capable of moving the map in two directions along the panning axis.

### BACKGROUND

Navigation systems display a map of the current location of a vehicle relative to nearby geographic features, such as roads. Users may wish to view a map location other than the area near the current vehicle position, or to view map data with a different scale. Some navigation systems provide controls that allow a user to vary the scale of map data displayed (to view more or less detail in a desired region), and to view different map regions.

### SUMMARY OF THE INVENTION

In one aspect, the invention is embodied in an apparatus for manipulating a display of a map. The apparatus includes a first control that is actuated to orient a panning axis for a vehicle navigation map display. An indicator that shows the panning axis orientation is displayed. A second control is actuated to move the map along the panning axis. Implementations can include one or more of the following features: The map moves in a first or second scrolling direction along the panning axis in response to actuation of the first control in a first or second direction, respectively. A linear, non-linear or discrete relationship exists between actuation of the first control and display of the map panning axis orientation. In the case of a discrete functional relationship, actuation of the first control is based on a selection from eight discrete alternative amounts.

According to various configurations, either or both of the first and second controls may be rotary controls. Controls may be arranged as concentric controls. The controls may also actuate a map zoom in or zoom out when pushed in or out. Both the rotary functions and zooming functions may be actuated by simultaneously rotating and pushing the control in or out.

In one specific aspect, the invention is embodied in a method for manipulating a map on a display in a vehicle navigation system. The method includes actuating a first function of a first control to orient a panning axis relative to the display. The method further includes actuating a first function of a second control to move the map relative to the panning axis. The second control is capable of moving the map in two directions along the panning axis. The method can also include indicating an orientation of the panning axis relative to the display.

Actuating the first function of the second control in a first direction moves the map in a first direction along the panning axis. Actuating the first function of the second control in a second direction moves the map in a second direction along the panning axis.

In one embodiment, a functional relationship between the actuation of the first function of the first control and the orientation of the panning axis is one of a linear, a non-linear and a discrete relationship. A functional relationship between the actuation of the first function of the second control and a movement of the map can be one of a linear, a non-linear, and a discrete relationship.

Actuating the first function of the first control can include rotating the first control and actuating the first function of the second control can include rotating the second control. Actuating a second function of the first control can include changing a displayed map scale. Actuating the second function of the first control can include pushing on the first control or pulling on the first control to zoom in the map. Actuating the second function of the first control can include pulling on or pushing in the first control to zoom out the map. The first and the second function of the first control are capable of being actuated substantially simultaneously.

Actuating a second function of the second control can change a displayed map scale. Actuating the second function of the second control can include pushing on or pulling on the second control to zoom in the map. Actuating the second function of the second control can include pulling on or pushing on the second control to zoom out the map. The first and the second function of the second control are capable of being actuated substantially simultaneously. The first function of the first control and the first function of the second control are capable of being actuated substantially simultaneously.

In another aspect, the invention is embodied in an apparatus for manipulating a map on a display in a vehicle navigation system. The apparatus includes a first control having a first function that orients a panning axis relative to the display. A second control includes a first function that moves the map along the panning axis. The second control is capable of moving the map in two directions along the panning axis. The apparatus can also include an indicator that is displayed on the map. The indicator indicates an orientation of the panning axis relative to the display.

The first control can include a rotary control. The second control can be a rotary control. The first and second controls can be arranged concentrically. In one embodiment, at least one of the first and second controls further includes a second function. The second function can be actuated upon pushing on the one of the first and second controls. The second function includes zooming in or zooming out the map.

At least one of the first and second controls further includes a second function. The second function is actuated upon pulling on the one of the first and second controls. The second function can include zooming in or zooming out the map. Actuating the second control in a first direction can move the map in a first direction along the panning axis. Actuating the second control in a second direction can move the map in a second direction along the panning axis.

In another aspect, the invention is embodied in a method for controlling a map on a display in a vehicle navigation system. The method includes actuating a first control in a first direction to zoom in the map and actuating the first control in a second direction to zoom out the map. The method can further include actuating a second control to move the map relative to the display. The method can also include indicating an orientation of a panning axis relative to the display.

In one embodiment, actuating a first control in a first direction includes pushing on the first control. Actuating a first control in a first direction can include pulling on the first control. Actuating a first control in a second direction can include pushing on or pulling on the first control

In another aspect, the invention is embodied in an apparatus for controlling a map in a vehicle navigation system. The apparatus includes a display that displays the map. A first control is located proximate to the display. The first control is pushed in to zoom in the map and pulled out to zoom out the map. Alternatively, the first control can be pushed in to zoom out the map and pushed in to zoom out the map. The first control can embody a rotary control. The first control can be a multifunctional control. The apparatus can also include a second control that is capable of moving the map relative to the display.

In another aspect, the invention is embodied in a vehicle navigation system. The system includes a display for displaying a map. A first rotary control orients a map panning axis. A second rotary control moves the map along the map panning axis. The first and the second rotary controls can be concentric. The system further includes an indicator that is displayed on the map for indicating an orientation of the map panning axis.

The first rotary control can also include a zoom function. The first rotary control can be pushed in to zoom in the map and pulled out to zoom out the map. Alternatively, the first rotary control can be pulled out to zoom in the map and pushed in to zoom out the map.

The second rotary control can also include a zoom function. The second rotary control can be pushed in to zoom in the map and pulled out to zoom out the map. Alternatively, the second rotary control can be pulled out to zoom in the map and pushed in to zoom out the map.

The invention may be operated in the form of a software program product.

### BRIEF DESCRIPTION OF THE DRAWINGS

The foregoing and other objects, features and advantages of the invention will be apparent from the following more particular description of embodiments of the invention, as illustrated in the accompanying drawings in which like reference characters refer to the same parts throughout the different views. The drawings are not necessarily to scale, emphasis instead being placed upon illustrating the principles of the invention.

FIG. 1 illustrates a navigation system having a navigation map display and user interface according to one embodiment of the invention;

FIG. 2 illustrates a navigation system having a navigation map display and user interface according to another embodiment of the invention;

FIG. 3 illustrates a navigation system according to the invention;

FIG. 4 illustrates the navigation system of FIG. 3 showing a compass arrow that displays the relative position of magnetic north on the navigation map display; and

FIG. 5 illustrates a navigation system installed in a vehicle.

### DETAILED DESCRIPTION

A navigation system according to one aspect of the invention provides users with a feature allowing them to view and manipulate the display of a navigation map. Map images displayed by a navigation system can be zoomed-in, thereby displaying more map detail over a smaller geographical area and/or zoomed-out, thereby displaying less map detail over a larger geographical area. The map area displayed can be controlled by a user in order to view alternate sections of the map. For example, users may wish to trace over their travel route by panning the map(s) (i.e., by using a pan control to cause the map display to scroll across a large area) if the travel route spans more map area than is displayed on the display screen at a given scale.

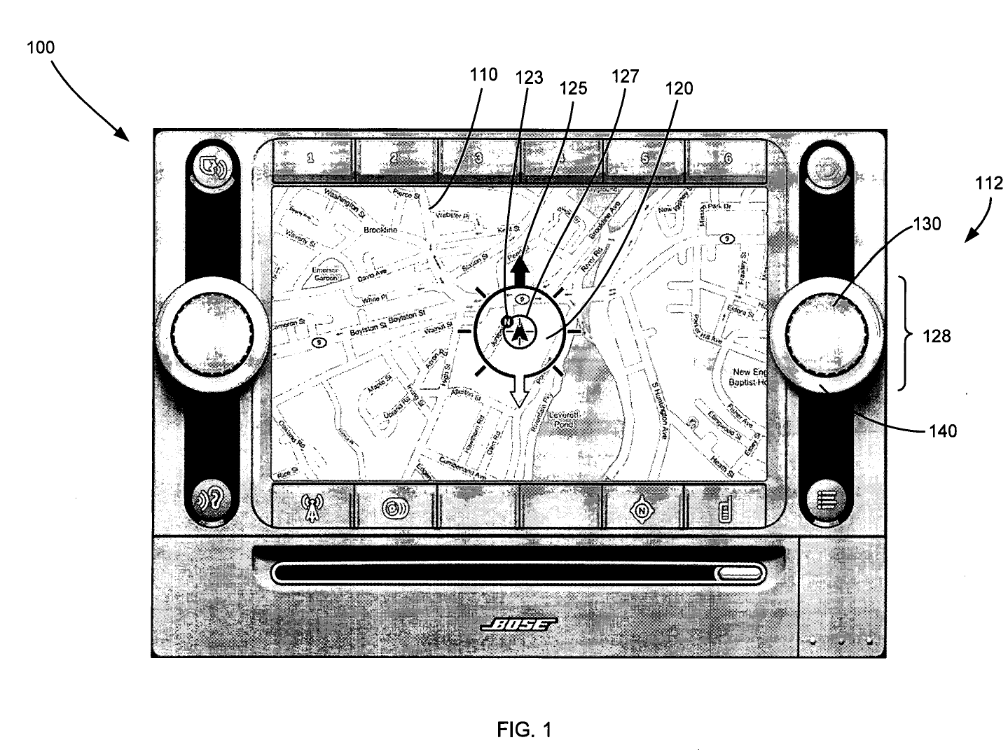

FIG. 1 illustrates a navigation system 100 having a navigation map display 110 and user interface 112 according to one embodiment of the invention. The map display 110 includes a panning axis indicator 120 with a pointer 125, a compass arrow 123, and a vehicle position indicator 127. Adjacent to map display 110 is control 128. In FIG. 1, control 128 is shown as a rotary style control having a first rotary control 130 and a second rotary control 140. However, other control mechanisms could be used for control 128 such as sliders, thumbwheels, etc. Rotary controls 130 and 140 may actuate an analog or digital controllable element, such as a potentiometer or rotary digital encoder, or any other controllable element. Alternatively, control 128 could consist of linear controls such as sliders, which can actuate potentiometers or linear digital encoders. The first and second controls 130, 140 are oriented concentrically, where first control 130 is the inner concentric control and second control 140 is the outer concentric control.

According to one configuration, actuation of the first control 130 controls the panning axis orientation; and actuation of the second control 140 controls map motion (i.e., scrolling) along the panning axis. In another configuration, these relationships are reversed.

Alternatively, a variable function single control could be used, wherein the single control functions to control the map panning axis in one mode of operation, and the single control functions to control the map scrolling along the panning axis in another mode of operation. The navigation system 100 may be part of a vehicle infotainment system in which the control 128 also controls other navigation operations, or non-navigation operations (e.g., multi-media controls, telecommunications controls, etc.).

By actuating (e.g., turning) the first control 130 (e.g., the inner concentric control) the user selects a panning axis along which the map can be scrolled. The pointer 125 of panning axis indicator 120 is displayed on the display 110 showing the map panning axis orientation. When the user actuates the first control 130, the pointer 125 rotates, changing its orientation. When the user actuates the second control 140 (e.g., rotates the outer concentric control), the map moves along the axis indicated by the pointer 125. Rotating (i.e., actuating) the second control 140 in a first direction (e.g., in the clockwise direction) causes the map to move in a first direction (e.g., to the right or up) along the map panning axis, and rotating the second control 140 in a second direction (e.g., counter clockwise) causes the map to move in the opposite direction (e.g., to the left or down) along the panning axis. Use of a rotary control for controlling map panning can allow the user to stabilize his/her hand when operating the controls. This feature can improve the preciseness of control of map movement.

Numerous different functional relationships can be used to couple the control operation to the map display. For example, numerous functional relationships can be used to couple control rotation (i.e., control 140 in the system of FIG. 1) to map movement. One relationship may be linear, where the amount of control rotation is proportional to the amount of visible map area that is moved. Another useful functional relationship may be non-linear. One example of a non-linear relationship is a function where the movement of the map display is proportional to the velocity of control rotation. Faster rotation results in scrolling over a larger area. The concepts described herein are not limited to the use of any particular functional relationship between control actuation and map movement.

Similarly, numerous functional relationships are also possible for coupling control rotation (i.e., control 130 in FIG. 1) to map panning axis orientation. One relationship may be linear, where the amount of control rotation is proportional to the orientation (or rotation) of the panning axis. Another useful functional relationship may be non-linear. An example of a non-linear relationship is a discrete function where the map panning axis orientation changes in discrete steps (e.g., four steps such as N, S, E, W or eight steps such as N, NE, E, SE, S, SW, W, NW, or other discrete step configurations, etc.) with control rotation. The concepts described herein are not limited to the use of any particular functional relationship between control actuation and map panning axis orientation.

It can be desirable to be able to control the relative scale of map data displayed on a navigation system map display 110. A user may wish to zoom in to see more map detail over a smaller area, or to zoom out to see less map detail over a larger area. A control arrangement for changing map scale involves pulling out or pushing in a control. For example the second control 140 can be pulled out to increase map scale and zoom out (to show a larger map area). Additionally, second control 140 can be pushed in to decrease the map scale and zoom in. These functions can be reversed, such that the second control 140 can be can be pushed in to increase map scale and zoom out or can be pulled out to decrease the map scale and zoom in. Control 128 can allow simultaneous pan and zoom, where a knob is both pulled or pushed and rotated at the same time. A control that can simultaneously scroll and zoom provides a convenient method of controlling the display of map information in a navigation system. In other configurations, the zoom controls can be separate from the panning axis and map scrolling controls.

Alternatively, operation of certain navigation features may necessitate automatically zooming-in or out as required during a panning operation. For example, if the user has selected an option to show three or more nearby restaurants, upon panning the map it may be necessary for the displayed map to be zoomed-out while the map is panned, in order to keep the three restaurants in the display window.

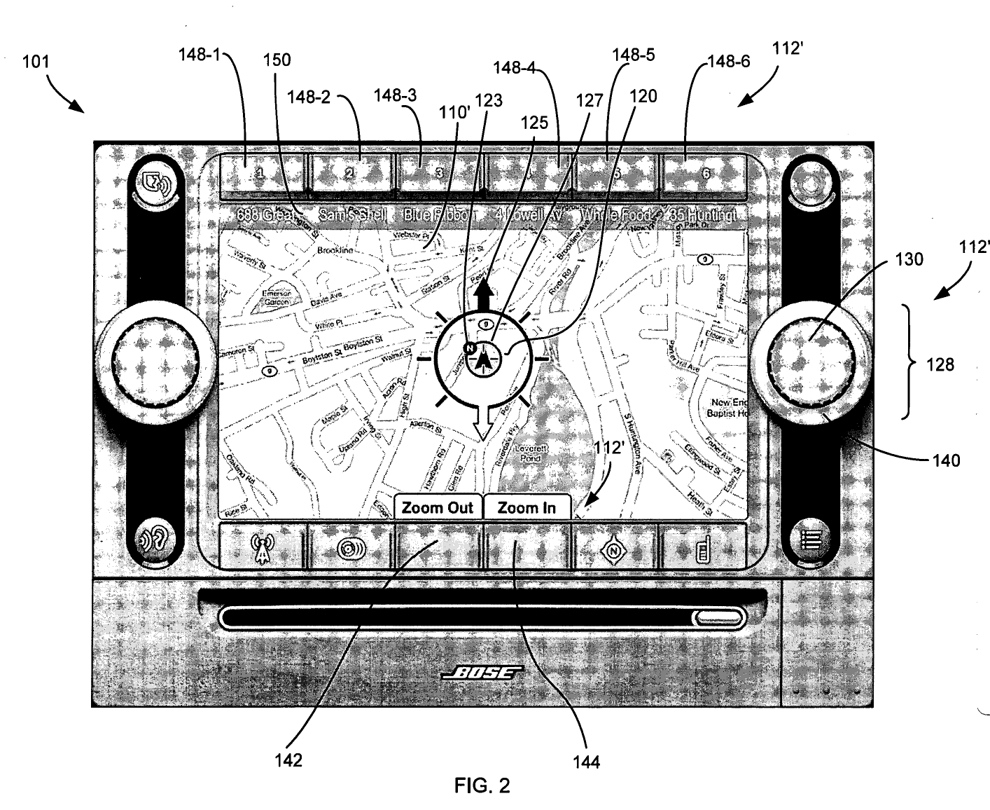

FIG. 2 illustrates a navigation system 101 having a navigation map displayl 10′ and user interface 112′ according to another embodiment of the invention. The navigation system 101 also includes soft button navigation controls 142, 144 located at the center bottom of the display 110′. Soft button controls or soft keys are called such because their functions can be changed or modified such that the same physical button can control different functions. Thus, soft buttons are programmable controls. Soft buttons can be changed to control different options under different circumstances. The function of the soft button is displayed adjacent to the physical button, and is updated whenever the function of the soft button is changed.

The soft button navigation controls 142, 144 can be used to control zoom functions. For example, the soft buttons 142, 144 at the center bottom of the display 110 represent options for zooming out and zooming in a displayed map. The soft buttons 148-1 to 148-6 located along the top of the display 110′ represent selection options 150 (e.g. 1-6) for different navigation destinations.

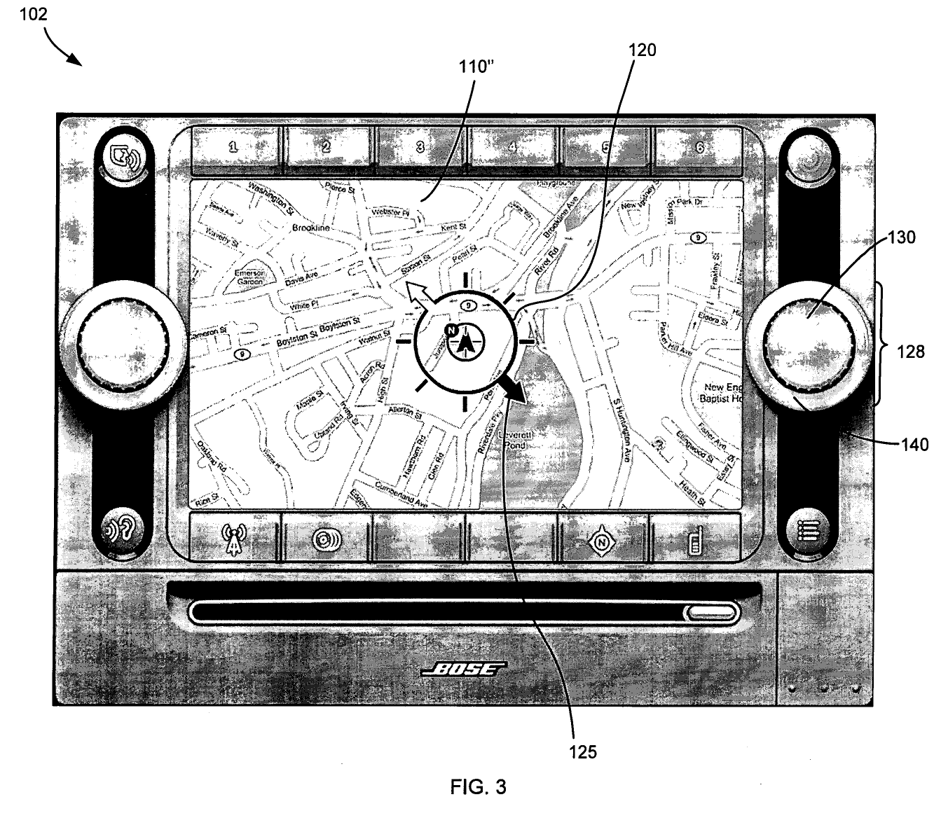

FIG. 3 illustrates a navigation system 102 according to the invention. The navigation system 102 includes a navigation map display 110″. The pointer 125 of panning axis indicator 120 shows the map panning axis orientation. In this example, the pointer 125 representing the panning axis points to the lower right of the display 110″. In order to orient the panning axis, the user rotates the first control 130 in a clockwise or counterclockwise direction to orient the panning axis in a north/south direction (i.e. relative to compass North). Rotation of second control 140 causes the map display to move along the north/south axis.

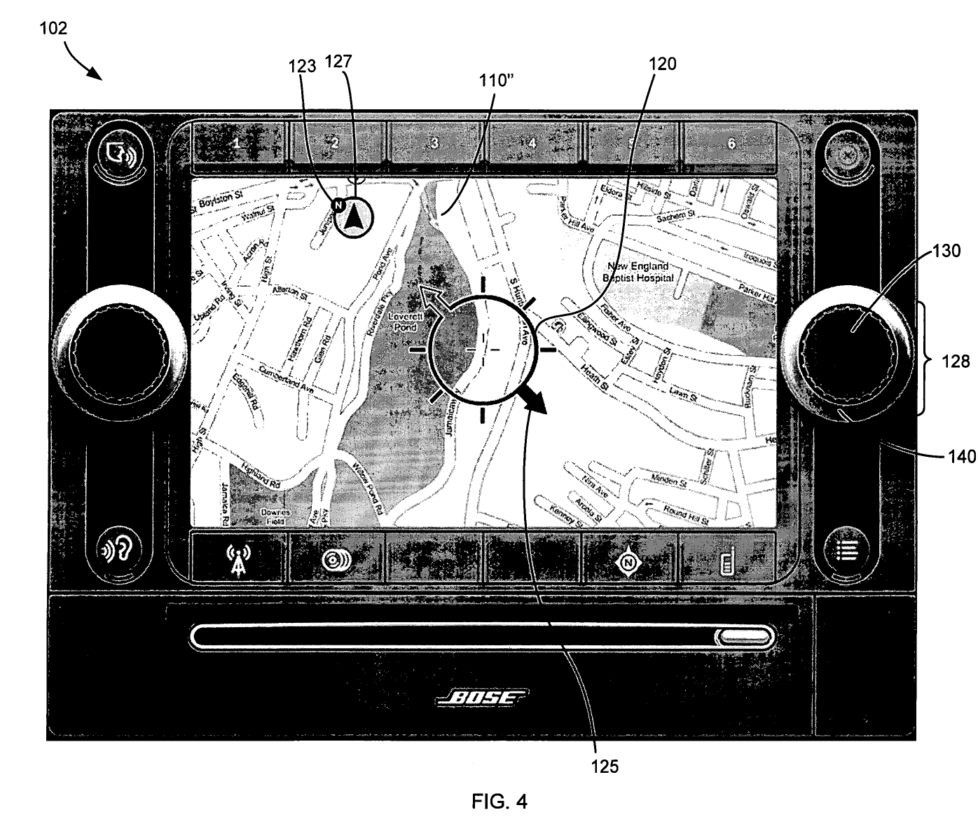

FIG. 4 illustrates the navigation system 102 of FIG. 3 showing a compass arrow 123 that displays the relative position of magnetic north on the navigation map display 110″. The navigation map display 110″ displays a map that has been moved a distance along a new panning axis. The pointer 125 remains centered on the map display 110″ while the position of the map is shifted in a northern direction relative to the position of the pointer 125. The vehicle position indicator 127 remains in the same relative location on the map (i.e., near Juniper Street, as shown in FIG. 3) which is representative of the actual vehicle location. The user can continue panning the map and look at additional locations by simply continuing to change the panning direction and/or scrolling the map by continuing to turn the first and second controls 130, 140.

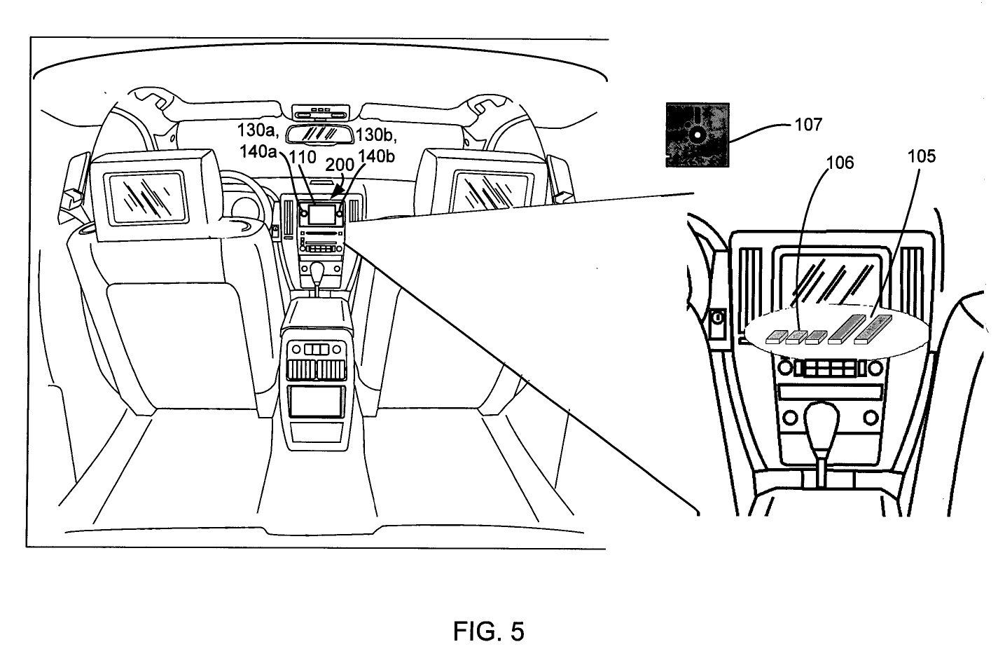

FIG. 5 illustrates a navigation system 200 installed in a vehicle. The navigation system 200 includes one or more input controls 130a, 140a, 130b, 140b, a processor 105, memory 106 and navigation program 107 stored on a computer readable medium. Program 107 may be stored on removable media such as a floppy disc, CD ROM, DVD ROM, etc., or may be stored on fixed media such as in memory or on a hard drive. As previously described, the navigation system 200 may operate in conjunction with other components of a vehicle infotainment system such as telecommunications equipment, AM radio, FM radio, CD player, and/or other components.

The navigation program 107 can be configured to operate on a general purpose computer including the processor 105 and memory 106. The program 107 can also include a map database that includes map data. Alternatively, the map data can be located in a remote database that can be accessed by the navigation program 107. The navigation program 107 can be controlled using the controls 130a, 140a, 130b, 140b. The processor processes actuations of the controls 130, 140, etc. and generates navigation information that is shown on a display 110″′ as previously described.

Thus as described in detail above, embodiments of the invention provide methods and mechanisms for panning a navigation map by the use of rotary or other controls in a manner that both improves precision and reduces system costs. Rotary controls employed are reliable and robust.

While this invention has been particularly shown and described with references to embodiments thereof, it will be understood by those skilled in the art that various changes in form and details may be made therein without departing from the spirit and scope of the invention, as defined by the appended claims.

What is claimed is:

1. A method for manipulating a map on a display in a vehicle navigation system, the method comprising:
actuating a first function of a first control to orient a panning axis relative to the display; and
actuating a first function of a second control to move the map relative to the panning axis, the second control being capable of moving the map in two directions along the panning axis.

2. The method of claim 1 further comprising indicating an orientation of the panning axis relative to the display.

3. The method of claim 1 wherein the actuating the first function of the second control in a first direction moves the map in a first direction along the panning axis.

4. The method of claim 1 wherein the actuating the first function of the second control in a second direction moves the map in a second direction along the panning axis.

5. The method of claim 1 wherein a functional relationship between the actuation of the first function of the first control and the orientation of the panning axis is one of a linear, a non-linear and a discrete relationship.

6. The method of claim 1 wherein a functional relationship between the actuation of the first function of the second control and a movement of the map is one of a linear, a non-linear, and a discrete relationship.

7. The method of claim 1 wherein the step of actuating the first function of the first control comprises rotating the first control and the step of actuating the first function of the second control comprises rotating the second control.

8. The method of claim 1 further comprising actuating a second function of the first control to change a displayed map scale.

9. The method of claim 8 wherein the actuating the second function of the first control comprises pushing on the first control to zoom in the map.

10. The method of claim 8 wherein the actuating the second function of the first control comprises pushing on the first control to zoom out the map.

11. The method of claim 8 wherein the actuating the second function of the first control comprises pulling on the first control to zoom out the map.

12. The method of claim 8 wherein the actuating the second function of the first control comprises pulling on the first control to zoom in the map.

13. The method of claim 8 wherein the first and the second function of the first control are capable of being actuated substantially simultaneously.

14. The method of claim 1 further comprising actuating a second function of the second control to change a displayed map scale.

15. The method of claim 14 wherein the actuating the second function of the second control comprises pushing on the second control to zoom in the map.

16. The method of claim 14 wherein the actuating the second function of the second control comprises pushing on the second control to zoom out the map.

17. The method of claim 14 wherein the actuating the second function of the second control comprises pulling on the second control to zoom out the map.

18. The method of claim 14 wherein the actuating the second function of the second control comprises pulling on the second control to zoom in the map.

19. The method of claim 14 wherein the first and the second function of the second control are capable of being actuated substantially simultaneously.

20. The method of claim 1 wherein the first function of the first control and the first function of the second control are capable of being actuated substantially simultaneously.

21. An apparatus for manipulating a map on a display in a vehicle navigation system, the apparatus comprising:
a first control having a first function that orients a panning axis relative to the display; and
a second control having a first function that moves the map along the panning axis, the second control being capable of moving the map in two directions along the panning axis.

22. The apparatus of claim 21 further comprising an indicator that is displayed on the map, the indicator indicating an orientation of the panning axis relative to the display.

23. The apparatus of claim 21 wherein the first control comprises a rotary control.

24. The apparatus of claim 21 wherein the second control comprises a rotary control.

25. The apparatus of claim 21 wherein the first and second controls are arranged concentrically.

26. The apparatus of claim 21 wherein at least one of the first and second controls further comprises a second function, the second function being actuated upon pushing on the one of the first and second controls.

27. The apparatus of claim 26 wherein the second function comprises zooming in the map.

28. The apparatus of claim 26 wherein the second function comprises zooming out the map.

29. The apparatus of claim 21 wherein at least one of the first and second controls further comprises a second function, the second function being actuated upon pulling on the one of the first and second controls.

30. The apparatus of claim 29 wherein the second function comprises zooming out the map.

31. The apparatus of claim 29 wherein the second function comprises zooming in the map.

32. The apparatus of claim 21 wherein actuating the second control in a first direction moves the map in a first direction along the panning axis.

33. The apparatus of claim 21 wherein actuating the second control in a second direction moves the map in a second direction along the panning axis.

34. A method for controlling a map on a display in a vehicle navigation system, the method comprising:
actuating a first control in a first direction to zoom in the map; and
actuating the first control in a second direction to zoom out the map.

35. The method of claim 34 further comprising actuating a second control to move the map relative to the display.

36. The method of claim 34 further comprising indicating an orientation of a panning axis relative to the display.

37. The method of claim 34 wherein actuating a first control in a first direction comprises pushing on the first control.

38. The method of claim 34 wherein actuating a first control in a first direction comprises pulling on the first control.

39. The method of claim 34 wherein actuating a first control in a second direction comprises pushing on the first control.

40. The method of claim 34 wherein actuating a first control in a second direction comprises pulling on the first control.

41. An apparatus for controlling a map in a vehicle navigation system, the apparatus comprising:
a display that displays the map; and
a first control that is located proximate to the display, the first control being pushed in to zoom in the map and pulled out to zoom out the map.

42. The apparatus of claim 41 wherein the first control comprises a rotary control.

43. The apparatus of claim 41 wherein the first control comprises a multifunctional control.

44. The apparatus of claim 41 further comprising a second control that is capable of moving the map relative to the display.

45. An apparatus for controlling a map in a vehicle navigation system, the apparatus comprising:
a display that displays the map; and
a first control that is located proximate to the display, the first control being pulled out to zoom in the map and pushed in to zoom out the map.

46. A vehicle navigation system comprising:
a display for displaying a map;
a first rotary control for orienting a map panning axis; and
a second rotary control for moving the map along the map panning axis.

47. The system of claim 46 wherein the first and the second rotary controls are concentric.

48. The system of claim 46 further comprising an indicator that is displayed on the map for indicating an orientation of the map panning axis.

49. The system of claim 46 wherein the first rotary control further comprises a zoom function, the first rotary control being pushed in to zoom in the map and pulled out to zoom out the map.

50. The system of claim 46 wherein the first rotary control further comprises a zoom function, the first rotary control being pulled out to zoom in the map and pushed in to zoom out the map.

51. The system of claim 46 wherein the second rotary control further comprises a zoom function, the second rotary control being pushed in to zoom in the map and pulled out to zoom out the map.

52. The system of claim 46 wherein the second rotary control further comprises a zoom function, the second rotary control being pulled out to zoom in the map and pushed in to zoom out the map.

53. An apparatus for manipulating a map on a display in a vehicle navigation system, the apparatus comprising:
means for actuating a first function of a first control to orient a panning axis relative to the display; and
means for actuating a first function of a second control to move the map relative to the panning axis, the second control being capable of moving the map in two directions along the panning axis.
